(19) United States
(12) Patent Application Publication
(10) Pub. No.: US 2024/0313467 A1
(43) Pub. Date: Sep. 19, 2024

(54) HIGH-VOLTAGE CONNECTOR SEAL RETENTION CLIP

(71) Applicant: Schaeffler Technologies AG & Co. KG, Herzogenaurach (DE)

(72) Inventors: Noah Kee, Rittman, OH (US); Brandon Heitger, Massillon, OH (US); Matthew Payne, Glenmont, OH (US)

(73) Assignee: Schaeffler Technologies AG & Co. KG, Herzogenaurach (DE)

(21) Appl. No.: 18/183,770

(22) Filed: Mar. 14, 2023

(51) Int. Cl. H01R 13/53; H01R 13/514; H01R 13/52

(52) U.S. Cl. CPC H01R 13/53; H01R 13/514; H01R 13/521

(57) ABSTRACT

A high-voltage connector having a connector body, at least one conductor supported in the connector body, and a seal member surrounding the at least one conductor at an interface of the connector body and the at least one conductor. A seal retainer secures the seal to prevent removal of the seal.

### FIELD

The present disclosure relates to sealing arrangements for high-voltage connectors.

### BACKGROUND

High-voltage connectors are used for connecting electrical components in electric cars. Typically, such connectors include cooperating male and female connector portions that can be engaged to make an electrical connection. One or more conductors (e.g., phase bars) supported in a first half of the connector (e.g., a high-voltage header) are adapted to be received in sockets or otherwise coupled to conductors supported in a second half of the connector (e.g., a terminal of electric motor for an electric or hybrid electric vehicle) when the connector halves are mated. In the case of a high-voltage header, the connection with the terminal of the electric motor is a sealed connection. As such, one or more seal elements are typically provided on the terminal of the electric motor to prevent oil or other fluid leakage from the electric motor.

### SUMMARY

In some applications, providing the seal element(s) on the terminal of an electric motor for an electric or hybrid vehicle has been found to be inadequate and/or unsatisfactory. However, in over-molded high-voltage connectors, such as high-voltage headers, that also function as a seal between wet and dry there is significant risk for oil (or other fluid) leakage from the electric motor between the plastic of the connector body and the copper phase bars. Different coefficients of expansion of the plastic of the connector body and the copper phase bar can open leak paths as the high-voltage connector is heat cycled. The present disclosure sets forth various sealing arrangements for sealing between the plastic of a connector body and the phase bars of a high-voltage header.

In accordance with one aspect, a high-voltage connector comprises a connector body, at least one conductor supported in the connector body, the conductor having a first end received in the connector body and a second end extending from the connector body for connection to a contact of a cooperating connector, and a seal member surrounding the at least one conductor at an interface of the connector body and the at least one conductor.

The connector body can include a counterbore surrounding the interface of the connector body and the at least one conductor. The seal member can be received in the counterbore of the connector body. A seal retainer can be at least partially received in the counterbore for restricting removal of the seal member. The seal retainer can be spaced apart from the seal member in a first exemplary arrangement. The seal retainer can engage the seal member in a second exemplary arrangement. The seal retainer can be secured to one or both of the connector body and at least one conductor. The seal retainer can be snap-fit to the at least one conductor. The seal retainer can include a seal retainer body having at least one flexible tab adapted to be received in a recess of the at least one conductor. The seal retainer can include a seal retainer body having a single opening for receiving a single conductor. The seal retainer can include a seal retainer body having multiple openings for receiving multiple conductors. The seal retainer body can be a unitary one-piece structure.

In accordance with another aspect, a seal retainer for retaining a seal member of an associated high-voltage connector having at least one conductor is set forth. The seal retainer comprises a seal retainer body having at least one opening for receiving the conductor, the seal retainer adapted to engage the conductor to restrict axial movement of the seal retainer along the conductor.

The seal retainer can include a seal retainer body having at least one flexible tab adapted to be received in a recess of the at least one conductor. The seal retainer can include a seal retainer body having a single opening for receiving a single conductor. The single opening can be elongate in cross section. The seal retainer can include an axially extending flange adapted to extend into a counterbore of the associated high-voltage connector surrounding the at least one conductor. The seal retainer can further include a radially extending flange adapted to abut a surface of the associated high-voltage connector surrounding the counterbore.

In accordance with another aspect, a method of assembling a high-voltage connector comprises providing a connector body having at least one conductor supported in the connector body, the conductor having a first end received in the connector body and a second end extending from the connector body for connection to a conductor of a cooperating connector, installing a seal member at an interface of the connector body and the at least one conductor, and installing a seal retainer over the at least one conductor and into contact with the connector body.

### BRIEF DESCRIPTION OF THE DRAWING(S)

FIG. 1 is a cross-sectional view of an exemplary high-voltage component.

FIG. 2 is a perspective view of a high-voltage connector in accordance with the present disclosure.

FIG. 3 is a cross-sectional view taken along the line 3-3 in FIG. 2.

FIG. 4 is an enlarged portion of FIG. 3.

FIG. 5 is an exemplary high-voltage connector having a seal retainer in accordance with the present disclosure.

FIG. 6 is a cross-sectional view taken along the line 6-6 of FIG. 5.

FIG. 7 is an enlarged portion of FIG. 6.

FIG. 8 is a perspective view of an exemplary seal retainer in accordance with the present disclosure.

FIG. 9 is a perspective view of another high-voltage connector in accordance with the present disclosure.

FIG. 10 is a cross-sectional view taken along the line 10-10 in FIG. 9.

FIG. 11 is a perspective view of another exemplary seal retainer in accordance with the present disclosure.

### DETAILED DESCRIPTION OF THE PREFERRED EMBODIMENT(S)

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. This terminology includes the words specifically noted above, derivatives thereof and words of similar import.

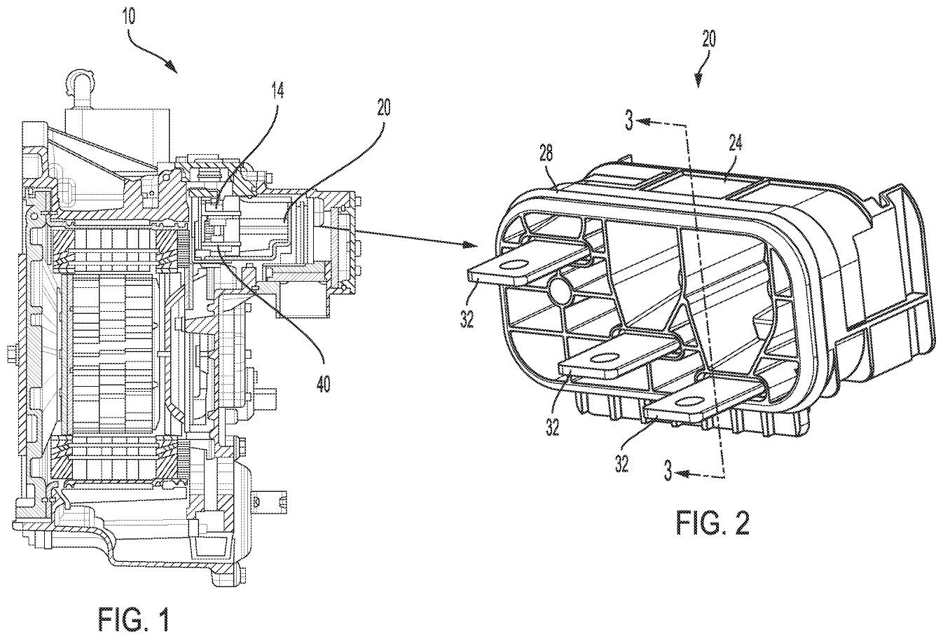

In FIGS. 1 and 2, a high-voltage component 10, such as an electric motor for an electric or hybrid electric vehicle, is illustrated. The high-voltage component 10 can be any of a wide range of high-voltage components and it will be appreciated that aspects of the present disclosure can be used in connection with any such high-voltage components. The high-voltage component 10 includes a high-voltage terminal 14 (e.g., a first connector portion) adapted to mate with a high-voltage connector 20 (e.g., a high-voltage header or a second connector portion).

The high-voltage connector 20 includes a connector body 24 which can typically be a plastic overmolded component. The connector body supports a seal 28 on its outer periphery for sealing with a corresponding surface of the high-voltage component 10 surrounding the terminal 14. Three phase bars 32 are supported by the connector body 24.

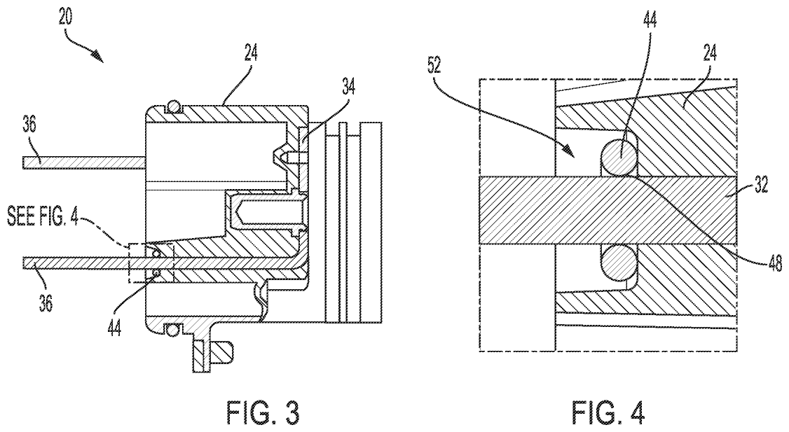

With additional reference to FIG. 3, each phase bar 32 includes a first end 34 received and secured in the connector body 24 and a second end 36 extending from the connector body 24 for connection to a corresponding phase bar 40 of the terminal 14 when the high-voltage connecter 20 is mated with the terminal 14.

A seal member 44 is provided on each phase bar 32 for sealing the phase bar 32 to the connector body 24 at an interface 48 therebetween. The seal members 44 can be o-ring type seal members, for example. As best seen in FIG. 4, each seal member 44 is received in a counterbore 52 (e.g., a recess) of the connector body 24 surrounding each phase bar 32. Each seal member 44 is generally annular and adapted to seal against corresponding surfaces of each phase bar 32 and the connector body 24.

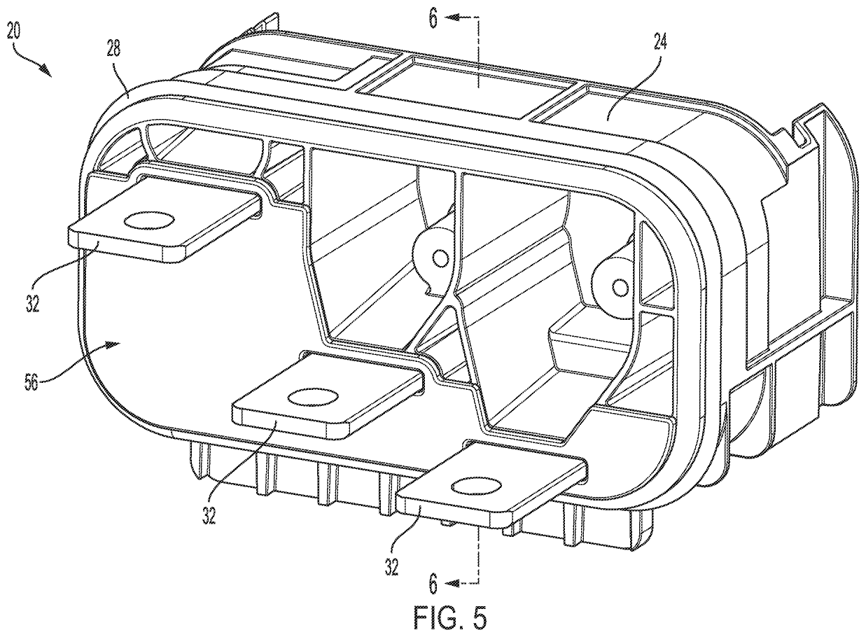

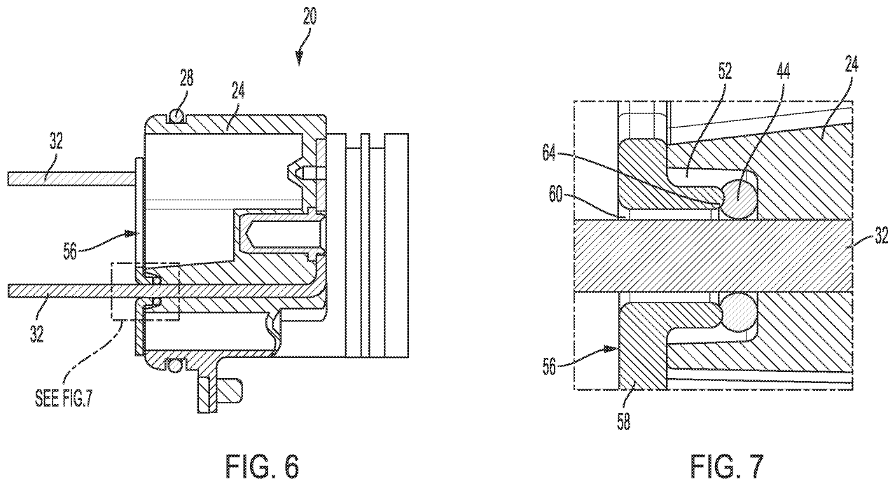

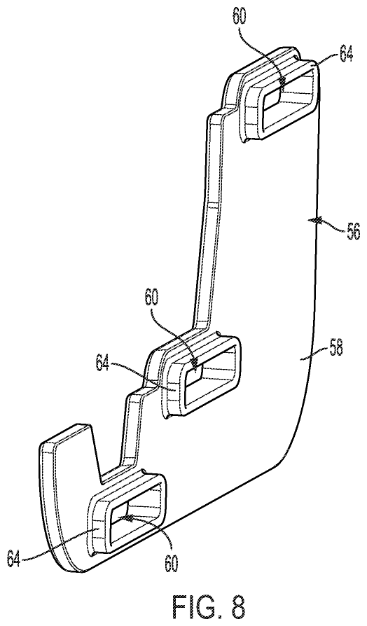

Turning to FIGS. 5-8, an exemplary seal retainer 56 is illustrated. The seal retainer 56 includes a seal retainer body 58 having openings 60 through which each phase bar 32 is telescoped during assembly of the seal retainer 56 with the connector body 24. The seal retainer 56 in the illustrated embodiment is adapted to be press-fit onto the connector body 24, but other connection styles are possible include a snap-fit arrangement. Surrounding each opening 60 is flange 64 extending axially with respect to the opening 60. Each flange 64 is received in a respective counterbore 52 and is configured to engage a respective seal member 44. Accordingly, the seal retainer 56 can apply a compressive force to the seal members 44 to enhance a sealing effect.

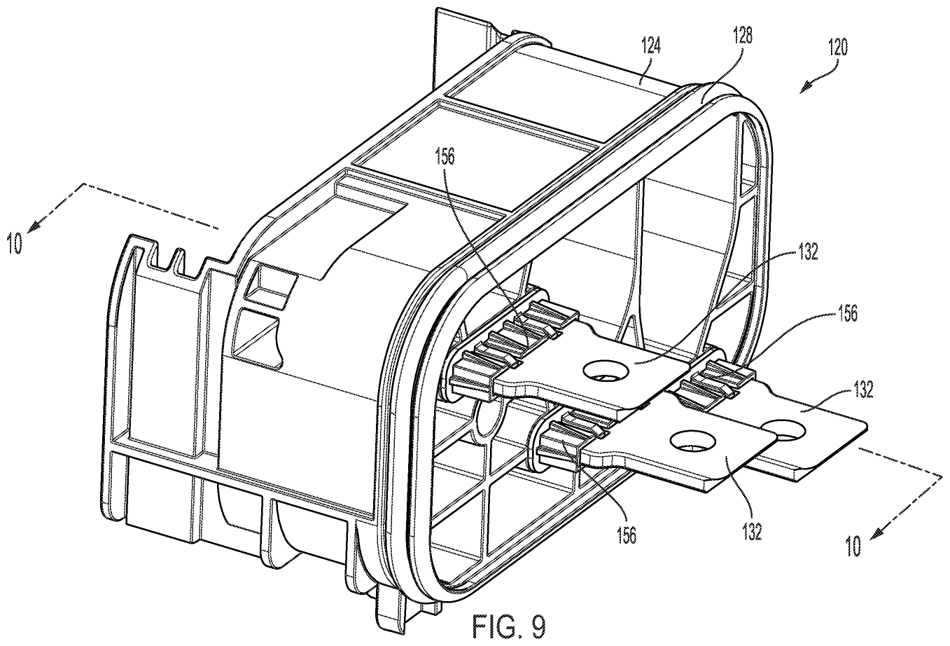

Referring now to FIGS. 9-11, another exemplary high-voltage connector is illustrated and identified generally by reference numeral 120. The high-voltage connector 120 is similar to the high-voltage connect 20 of FIGS. 1-8 with a primary difference being that individual seal retainers are provided for each phase bar. The high-voltage connector 120 includes a connector body 124 that supports a seal 128 on its outer periphery for sealing with a corresponding surface of the high-voltage header 14. Three phase bars 132 are supported by the connector body 124.

Each phase bar 132 includes a first end 134 received and secured in the connector body 124 and a second end 136 extending from the connector body 124 for connection to a corresponding phase bar 40 of the high-voltage header 14 when the high-voltage connecter 120 is mated with the terminal 14.

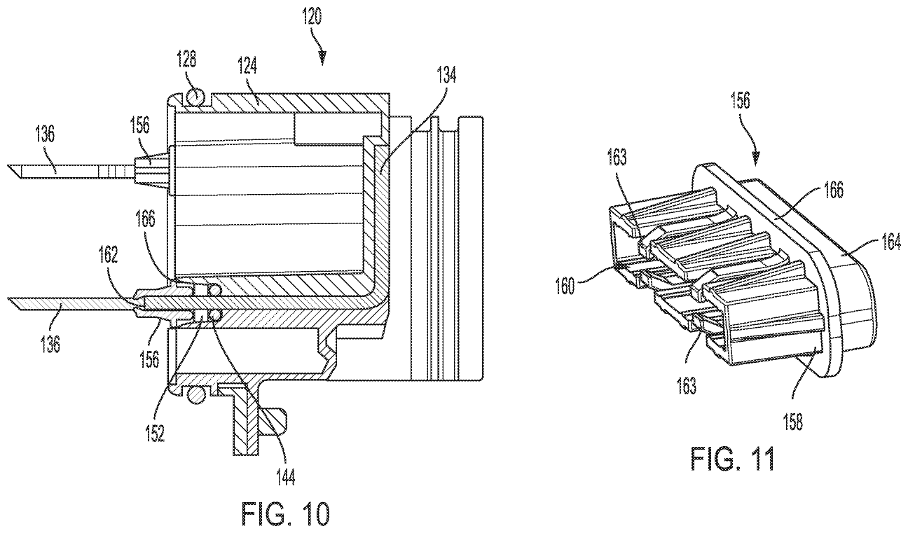

A seal member 144 is provided on each phase bar 132 for sealing the phase bar 132 to the connector body 124 at an interface therebetween. The seal members 144 can be o-ring type seal members, for example. As best seen in FIG. 10, each seal member 144 is received in a counterbore 152 (e.g., a recess) of the connector body 124 surrounding each phase bar 132. Each seal member 144 is generally annular and adapted to seal against corresponding surfaces of each phase bar 132 and the connector body 124.

Individual seal retainers 156 are received in the connector body 124. Each seal retainer 156 includes a seal retainer body 158 having an opening 160 through which a phase bar 132 is telescoped during assembly of the seal retainer 156 with the connector body 124. In the illustrated embodiment the opening 160 is elongate in cross-section. The seal retainers 156 in the illustrated embodiment are adapted to be snap-fit onto the phase bars 132, but other connection styles are possible. Each phase bar 132 includes recesses 162 for receiving tangs 163 of the seal retainers 156. The tangs 163 are flexible such that during installation of a seal retainer 156 onto a phase bar 132 the tangs flex outwardly to allow the seal retainer 156 to be telescoped over the phase bar 132. Once the tangs 163 align with the recesses 162, the tangs snap inwardly and engage the phase bar 132 to prevent removal of the seal retainer 152.

Surrounding the opening 160 of each seal retainer 152 is flange 164 extending axially with respect to the opening 160. Each flange 164 is received in a respective counterbore 152. In this embodiment, the flanges 164 are spaced from the seal members 144. Accordingly, limited axial movement of the seal members 144 is possible. A radially outwardly extending flange 166 abuts a surface of the connector body 124 surrounding the counterbore 152.

Having thus described the present disclosure in detail, it is to be appreciated and will be apparent to those skilled in the art that many physical changes, only a few of which are exemplified in the detailed description of the invention, could be made without altering the concepts and principles embodied therein.

It is also to be appreciated that numerous embodiments incorporating only part of an embodiment are possible which do not alter, with respect to those parts, the concepts and principles embodied therein.

The present embodiment and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

### LOG OF REFERENCE NUMERALS

high-voltage component 10
high-voltage terminal 14
high-voltage connector 20
connector body 24
seal 28
phase bar 32
first end 34
second end 36
phase bar of the high-voltage terminal 40
seal member 44
interface 48
counterbore 52
seal retainer 56
seal retainer body 58
opening 60
flange 64
high-voltage connector 120
connector body 124
seal 128
phase bar 132
first end 134
second end 136
seal member 144
counterbore 152
seal retainer 156
seal retainer body 158
opening 160
recesses 162
tangs 163
axially extending flange 164
radially extending flange 166

What is claimed is:

1. A high-voltage connector comprising:
a connector body;
at least one conductor supported in the connector body, the at least one conductor having a first end received in the connector body and a second end extending from the connector body for connection to a conductor of a cooperating connector; and
a seal member surrounding the at least one conductor at an interface of the connector body and the at least one conductor.

2. The high-voltage connector of claim 1, wherein the connector body includes a counterbore surrounding the interface of the connector body and the at least one conductor.

3. The high-voltage connector of claim 2, wherein the seal member is received in the counterbore of the connector body.

4. The high-voltage connector of claim 3, further comprising a seal retainer at least partially received in the counterbore for restricting removal of the seal member.

5. The high-voltage connector of claim 4, wherein the seal retainer is spaced apart from the seal member.

6. The high-voltage connector of claim 4, wherein the seal retainer engages the seal member.

7. The high-voltage connector of claim 4, wherein the seal retainer is secured to the connector body.

8. The high-voltage connector of claim 4, wherein the seal retainer is secured to the at least one conductor.

9. The high-voltage connector of claim 8, wherein the seal retainer is snap-fit to the at least one conductor.

10. The high-voltage connector of claim 9, wherein the seal retainer includes a seal retainer body having at least one flexible tab adapted to be received in a recess of the at least one conductor.

11. The high-voltage connector of claim 4, wherein the seal retainer includes a seal retainer body having a single opening for receiving a single conductor.

12. The high-voltage connector of claim 4, wherein the seal retainer includes a seal retainer body having multiple openings for receiving multiple conductors.

13. The high-voltage connector of claim 12, wherein the seal retainer body is a unitary one-piece structure.

14. A seal retainer for retaining a seal member of an associated high-voltage connector having at least one conductor, the seal retainer comprising:
a seal retainer body having at least one opening for receiving the at least one conductor, the seal retainer adapted to engage the conductor to restrict axial movement of the seal retainer along the conductor.

15. The seal retainer of claim 14, wherein the seal retainer includes a seal retainer body having at least one flexible tab adapted to be received in a recess of the at least one conductor of the associated high-voltage connector.

16. The seal retainer of claim 14, wherein the seal retainer includes a seal retainer body having a single opening for receiving a single conductor.

17. The seal retainer of claim 16, wherein the single opening is elongate in cross-section.

18. The seal retainer of claim 17, further comprising an axially extending flange adapted to extend into a counterbore of the associated high-voltage connector surrounding the at least one conductor.

19. The seal retainer of claim 18, further comprising a radially extending flange adapted to abut a surface of the associated high-voltage connector surrounding the counterbore.

20. A method of assembling a high-voltage connector comprising:
providing a connector body having at least one conductor supported in the connector body, the conductor having a first end received in the connector body and a second end extending from the connector body for connection to contact of a cooperating connector;
installing a seal member at an interface of the connector body and the at least one conductor; and
installing a seal retainer over the at least one conductor and into contact with the connector body.
